(19) United States
(12) Patent Application Publication
(10) Pub. No.: US 2001/0046462 A1
(43) Pub. Date: Nov. 29, 2001

(54) Pulsed flow fuel processing system

(76) Inventors: Richard Woods, Long Beach, CA (US); Joshua Mauzey, Long Beach, CA (US)

Correspondence Address: COLIN P ABRAHAMS, 5850 CANOGA AVENUE, SUITE 400, WOODLAND HILLS, CA, 91367

(21) Appl. No.: 09/827,257

(22) Filed: Apr. 5, 2001

Related U.S. Application Data
(60) Provisional application No. 60/194,712, filed on Apr. 5, 2000.

(51) Int. Cl. B01J 8/00; C01B 3/24

(52) U.S. Cl. 422/211; 422/189; 48/197 R; 48/127.9

(57) ABSTRACT

An autothermal reactor for the generation of a hydrogen-containing product gas stream from a feed gas stream comprises a reactor vessel having a feed gas stream inlet end and a product gas outlet end. A partial oxidation catalyst is located within the reactor vessel and positioned in the path of the feed gas stream. A steam methane reforming catalyst is located within the reactor vessel and positioned downstream from the partial oxidation catalyst in the path of the feed-gas stream. A first inlet is provided to introduce a first feed gas stream component selected from the feed gas component stream group comprising a hydrocarbon fuel, oxidant, and steam. The first inlet is located at the fuel gas stream inlet end of the reactor vessel. A mechanism to pulsate is associated with the first inlet to pulsate the flow of the first feed gas stream component into the autothermal reactor.

### CROSS REFERENCE TO RELATED APPLICATIONS

This application claims the benefit of U.S. Provisional application No. 60/194,712 filed Apr. 5, 2000.

### FIELD OF THE INVENTION

This invention relates to the use of pulsed flows in a fuel processing system for the production of Hydrogen for fuel-cells and other commercial or industrial applications.

### BACKGROUND OF THE INVENTION

Auto-Thermal Reformers (ATR) have long been used to produce a Hydrogen-rich gas-stream for use as a fuel in Fuel-Cells. Typically, an ATR consists of a two-stage reaction vessel wherein a feed-gas stream, which consists of a mixture of steam, gaseous hydrocarbon based fuel, and an oxidant such as oxygen or air is converted to a hydrogen-rich product-gas stream. The first stage is generally referred to as a Catalytic Partial Oxidizer (CPO) and consists of a layer of a first catalytic material located in the path of flow of the feed-gas stream. In the CPO, the feed gas stream is converted to a synthesis gas stream consisting of Hydrogen, Carbon-Monoxide, Carbon Dioxide, methane, Steam, and other inert gases such as Nitrogen that may have been present in the feed-gas stream. The partially oxidized gas-stream is then introduced into the second stage of the ATR.

The second stage is generally referred to as a Steam-Methane Reformer (SMR) and consists of a layer of a second catalytic material located in the path of flow of the partially oxidized gas stream. In the SMR, the catalyst converts the methane and steam to hydrogen and Carbon-Monoxide and Carbon-dioxide. Thus the SMR further increases the concentration of Hydrogen in the gas-stream to create a hydrogen-rich product gas stream, which is used as a fuel for the production of electricity in a Fuel-Cell.

In state of the art ATR systems, the process operates with a stoichiometric ratio of about 0.25 or 0.5 moles of oxygen for every mole of CH4. In advanced systems (such as those described in co-pending U.S. patent application Ser. No. 732,230), external heat addition is optimized to allow operation at stoichiometric ratios of slightly under 0.20 or 0.4 moles O2 for every mole of CH4. Practical limitations on external heat exchange and combustion temperatures have prevented further increases in efficiency.

Therefore, an improved ATR is required to provide the highest efficiency and increased concentration of Hydrogen in the product gas stream. Such an ATR should be economical to manufacture, easy to operate, rugged in design, and simple to maintain.

### SUMMARY OF THE INVENTION

According to one aspect of the invention, there is provided an autothermal reactor for the generation of a hydrogen-containing product gas stream from a feed gas stream, the autothermal reactor comprising: a reactor vessel having a feed gas stream inlet end and a product gas outlet end; a partial oxidation catalyst located within the reactor vessel and positioned in the path of the feed gas stream; a steam methane reforming catalyst located within the reactor vessel and positioned downstream from the partial oxidation catalyst in the path of the feed-gas stream; a first inlet means to introduce a first feed gas stream component selected from the feed gas component stream group comprising a hydrocarbon fuel, oxidant, and steam, the first inlet means located at the fuel gas stream inlet end of the reactor vessel; and means to pulsate associated with the first inlet means to pulsate the flow of the first feed gas stream component into the autothermal reactor.

According to another aspect of the invention, there is provided a method of generating a hydrogen-containing product gas from an autothermal reactor containing a partial oxidation catalyst and a steam methane reforming catalyst, the method comprising the steps of: pulsatingly introducing a feed gas mixture comprising a first feed gas stream component selected from the feed gas component group comprising a hydrocarbon fuel, oxidant, and steam into the autothermal reactor; passing the feed gas mixture over the partial oxidation catalyst to produce a partially oxidized product gas stream; passing the feed gas mixture over the steam methane reforming catalyst to generate the hydrogen-containing product gas stream; and removing the hydrogen-containing product gas stream generated from the autothermal reactor.

In one aspect, the present invention is directed to an apparatus and a process for pulsing the feed components in the feed-gas mixture to an autothermal reformer (ATR) in order to enhance the hydrogen yield of the ATR. Further, the present invention may improve the efficiency of an ATR by maximizing heat recovery in the steam methane reforming (SMR) section.

Further, in one aspect the present invention may produce more hydrogen than ATRs of the prior art without a corresponding increase in fuel consumption. Yet further, the heat transfer and catalytic activity, which is one effect of the invention, may improve with the use of pulsed feed gas component flow in the ATR. A further advantage of the invention is also that the product gas from the complete fuel processing system can be easily designed to provide a relatively constant hydrogen concentration, which in turn enhances steady state fuel cell performance.

In another aspect, the product gas provided by the present invention from the complete fuel processing system can be designed to provide a hydrogen concentration, which increases and decreases with the progression of the composition wave developed within the ATR. A benefit of this varying hydrogen concentration tuning ability may be the possibility of increasing the overall carbon monoxide (CO) tolerance of the fuel cell system through momentary fuel starvation. This increases the electrical production capacity and the longevity of the Fuel Cell while also reducing the maintenance requirements thereof.

The present invention preferably utilizes hydrocarbon fuels for the production of hydrogen gas as its primary application. This hydrogen gas can then be used for fuel cell power generation applications in various devices, including both stationary and vehicular markets. The hydrogen produced in accordance with the invention can also be used for industrial hydrogen generation systems where hydrogen is the desired customer product.

Yet other advantages of the ATR of the present invention will become apparent from a consideration of the attached drawings and the following description.

### BRIEF DESCRIPTION OF THE DRAWINGS

FIG. 1 is a schematic view representing the state of the art autothermal reforming process;

FIG. 2 is a schematic representation of a pulsed flow autothermal reforming process apparatus of the present invention;

FIG. 3 is a graphical representation showing the flow-rate of the various feed gas components within the ATR, of the present invention, represented in FIG. 2, wherein the oxidant flow-rate is cyclically varied while the other feed gas components are kept at a constant flow;

FIG. 4 is a graphical representation of the operating temperature within the CPO and SMR stages of the ATR of the present invention, operating in accordance to the flow criteria of FIG. 2;

FIG. 5 is a graphical representation of the concentration of Hydrogen in the product gas stream for an ATR of the present invention, which is operated in accordance to the flow criteria of FIG. 3;

FIG. 6 is an alternative embodiment of the process and apparatus for creating the pulsed oxidant flow into the autothermal reforming process of the present invention, wherein the oxidant flow is pulsed using a pulsating flow air-compressor;

FIG. 7 is another alternative embodiment of the process and apparatus for creating the pulsed oxidant flow into the autothermal reforming process of the present invention, wherein the oxidant flow is pulsed using a pulsing valve mounted in the supply line;

FIG. 8 is a representation of an ATR which uses pulsed fuel flow and which uses uncoated monolith slices to create a resonating flow within an advanced catalyst coated monolith within the ATR;

FIG. 9 is a cross-sectional representation of a ATR which shows a gas injector which is configured as a helical coil and which is used for the injection of natural gas into a air-stream gas stream flowing past the injector; and

FIG. 10 is a representation of a graph showing the variation of the concentration of natural gas in a cross-section of the ATR.

### DETAILED DESCRIPTION OF THE INVENTION

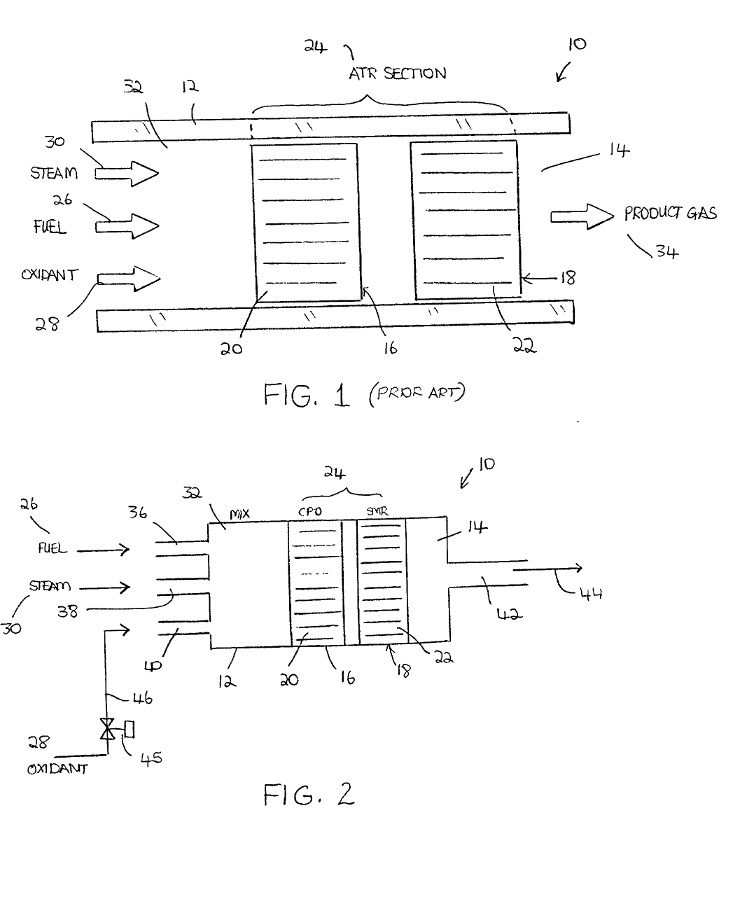

With reference to FIG. 1 of the drawings, there is shown a state of the art autothermal reformer indicated by reference numeral 10. The autothermal reformer comprises a reactor shell 12 defining a reaction volume 14.

Reactor shell 12 can be a standard metallic or non-metallic tube or pressure vessel. Within volume 14 there is a first catalyst section 16 and a second catalyst section 18. The first catalyst section 16 includes a partial oxidation catalyst 20, while the second catalyst section includes the steam methane reforming catalyst 22. The combination of these two catalysts 20 and 22 are sometimes referred to as the ATR (autothermal reformer) section 24.

As defined herein, a partial oxidation catalyst is a catalyst, which partially oxidizes a hydrocarbon to hydrogen, carbon monoxide, and other products of partial combustion according to the chemical reaction equation

CH4+0.5(O2)→CO+2(H2)+Heat.

In this reaction, methane is indicated as the partially oxidizing hydrocarbon, but other hydrocarbons such as propane, butane, pentane, etc. could also be used to provide a partially oxidized gas stream mixture consisting mainly of carbon monoxide and hydrogen. Liquid hydrocarbon fuels such as but not limited to kerosene or gasoline could also be used in the ATR.

Partial oxidation catalysts are generally precious metal-based and are well known in the art and can be readily obtained in the USA from manufacturers such as Engelhard Corporation. The active-catalyst material, which is generally platinum or palladium is usually coated on a high-surface area, highly porous, non-catalytic substrate material such as a ceramic base to provide a very large number of active catalyst sites per unit volume of the catalyst. Further the catalyst can be configured in a granulated or pellet form for economical reasons or can be configured in a monolithic form to provide a low operating pressure drop. Yet further, the catalyst can be configured as a fixed packed bed or a fluidized bed without substantially deviating from its function of partially oxidizing the feed gas-stream.

Further as defined herein, a steam methane reforming catalyst is a catalyst, which converts the methane and steam in the partially oxidized gas stream described above to carbon-monoxide and hydrogen according to the chemical reaction equation:

Heat+CH4+H2O→CO+3H2.

The SMR catalyst also promotes the equilibrium between carbon monoxide and carbon dioxide by converting the carbon monoxide and steam in the feed-gas stream to hydrogen and carbon dioxide according to the chemical reaction equation, commonly known as water-gas-shift reaction:

CO+H2O→CO2+H2+heat.

Thus the steam methane reforming catalyst further increases the yield of hydrogen from the autothermal reactor.

Conventional steam methane reforming catalysts are generally metal-oxide based and are well known in the art. Steam methane reforming catalysts made of nickel on alumina with certain promoters and are readily available in the US from manufacturers such as United Catalyst. Advanced SMR catalysts are generally made up of noble metals such as platinum, palladium or rhodium and are supplied by Engelhard Corporation. As in the case of the partial oxidation catalyst, the active SMR catalyst material is generally coated on a high-surface area, highly porous, non-catalytic substrate material such as a ceramic base to provide a very large amount of active catalyst sites per unit volume of the catalyst. Further the SMR catalyst can be configured in a granulated or pellet form for economical reasons or can be configured in a monolithic form to provide a low operating pressure drop. Yet further, the catalyst can be configured as a fixed packed bed or a fluidized bed without substantially deviating from its function.

Referring once more to FIG. 1 of the drawings, the feed gases enter reaction volume 14 defined by reactor shell 12. The feed gases comprise fuel 26, and oxidant 28, and/or steam 30. The oxidant 28 would typically consist of air or air enriched with oxygen. These gases 26, 28 and 30 are premixed in the premixing chamber 32 and thereafter directed though the ATR section 24 comprising the first and second catalyst sections 16 and 18. Within the ATR section 24, chemical reactions occur, resulting in the formation of a product gas 34, which consists primarily of hydrogen (H2), carbon monoxide (CO), carbon dioxide (CO2), water vapor (H2O) and residual or non-reactive nitrogen (N2), water or steam (H2O), unoxidized fuel such as methane (CH4), and other products of partial oxidation.

In one embodiment of the invention the feed gases comprising fuel 26, oxidant 28, and/or steam 30 are uniformly pulsed into the mixing section 32 and first catalyst section 16. This pulsing of the feed gases propagates into first catalyst section 16 in which the feed gases begin to react on the partial oxidation catalyst 20. The pulsing flow enhances the turbulent mixing within the catalyst section 16 enhancing the process and reducing the required actual resonance time needed for catalyst section 16. This improves the design space velocity. In addition the pulsed flow characteristic causes the reaction front to move up and down along the length of the flow path in catalyst section 16. The baseline ATR has actual resonance times of 0.010 to 0.050 seconds or design space velocities at standard conditions of 30,000 to 140,000 hr-1. The pulsating reaction will also cause pulsating flow characteristics along heat transfer surfaces within the reactor, which will disrupt boundary layers and enhance heat transfer characteristics.

Reference is now made to FIG. 2 of the drawings, which shows another embodiment of the invention. FIG. 2 shows an autothermal reactor 10 having a reactor shell 12, which defines a space 14 including a premixing chamber at one end 32. First and second catalytic sections 16 and 18 respectively are located within the space 14. The first catalytic section includes the partial oxidation catalyst 20, while the second catalytic section includes the steam methane reforming catalyst 22. The first and second sections 16 and 18 together define the ATR (autothermal reformer) section, designated by reference numeral 24.

The feed gas, consisting of a fuel, an oxidant, and steam is introduced through feed connections 36, 38, and 40 respectively. Thus, in FIG. 2, fuel 26 is introduced through connection 36, while steam 30 is introduced through connection 38. In this particular embodiment, the oxidant 28 is introduced through the connection 40. The fuel 26, steam 30 and oxidant 28 comprise the feed gas stream which is introduced into the premixing chamber 32 where initial mixing thereof takes place. This premixing chamber is designed such that good mixing is achieved within the time cycle of the pulsed flow characteristics and such that poor mixing is achieved between the peak of the pulse and the valley of the pulse. This can be achieve by a structure of several, thin monolithic slices with gaps or spaced between consecutive slices. The resonance time of a slice-gap section is adjusted to cycle time of the pulses introduced into the reactor. The hydrogen-rich gas stream that is generated by the reaction of the process gases introduced into the system exit the autothermal reformer 10 through exit line 42 as product gases 44.

The process gases 26, 28 and 30 are introduced to the autothermal reformer 10 at relatively constant average flow rates, in proportion to the capacity output of the system. Typical control systems may be provided that modulate the proportional flow control as the capacity of the unit is increased or decreased.

For example, to provide the fuel requirements for a 7 kW Fuel Cell, the relative flow rates of fuel, air, and steam would be about 4.5, 20, and 14 lbs/hr respectively. In the case of a 50-kW Fuel Cell, the relative flow rates would be 30, 140, and 100 lbs/hr respectively. These are examples only, and it should be noted that the system requirements will vary according to configuration, environment and other factors and/or variables.

In the embodiment shown in FIG. 2, a valve 45 is provided in the line supplying oxidant 28 to the autothermal reformer 10. The valve 45 is located in supply line 46, which ultimately introduces the oxidant through the connection 40. The other feed gases, in this example fuel and steam, are introduced through lines 36 and 38, respectively. The feed gases could also be premixed and feed into chamber 32 through only a single connection such as line 36.

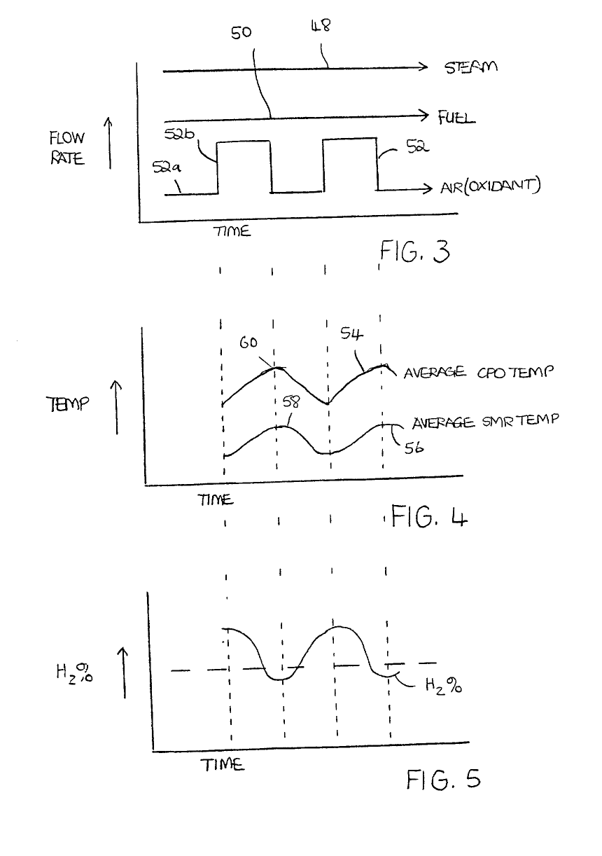

In this embodiment of the invention, the steam 30 and fuel 26 are introduced into the reaction at relatively constant flow rates. This can be seen with reference to FIG. 3 of the drawings, where line 48 shows the constant supply of steam, while line 50 shows a relatively constant supply of fuel. The valve 45 shown in FIG. 2 is opened and closed sequentially, or it may be activated by a pulse-width modulating control such that the oxidant 28 enters the reaction in pulses. Once more, this pulsed introduction of the oxidant is illustrated by line 52 in FIG. 3 of the drawings. The line 52 shows section 52a where oxidant is cut off, or its flow is substantially reduced. However, upon opening of the valve 45, the flow rate of oxidant increases to the level indicated by reference numeral 52b along line 52.

When the oxidant is introduced, the stoichiometric ratio of the catalytic partial oxidation reaction pulses. As this reaction occurs, heat is generated and begins to locally increase the temperature of the support structure of the monolith. The momentum wave created by both the pulsed mass flow and volumetric expansion of the reaction accelerates the gas flow and helps to disrupt diffusion layers enhancing heat transfer within the SMR section 18. When the oxidant is decreased, the stoichiometric ratio decreases and less heat is generated. As the fuel-steam rich pulse enters the catalyst, steam reformation begins to dominate and this endothermic reaction begins to cool the support structure of the monolith.

The flow control valve 45 can be any standard control valve that is generally used for the control of gas-flow. Thus flow-control valve 45 could be a damper, a butter-fly valve, a plunger-type valve, a needle valve, an adjustable orifice, a slide-gate valve, an adjustable constriction, a rotary valve, or any other means of adjusting flow including a diverter valve which diverts or re-introduces a part of a gas out of or into the system. Such valves are readily available in the US from manufacturers such as Maxon, Eclipse, DeZurik, etc.

The flow-control valve 45 can be actuated by any kind of pneumatic, hydraulic, or electrical controller such as a piston, or electric linear motor or an electric rotor. Cam means can also be used to convert the steady rotary action of an electrical motor or steam turbine into a cyclically unbalanced rotary action to cyclically move the flow-restricting element in the valve between a pre-determined range of positions and provide an oscillatory flow pattern in the valve. Such controllers and cam means are readily available in the US from manufacturers such as Barber-Colman, Honeywell, Kinetrol, etc.

While the above description indicates that the oxidant flow is being pulsed while the flow of fuel and steam is kept relatively constant, the present invention can also be practiced by pulsing any one of the three feed gas stream components and keeping the flow of the remaining two components constant. Thus, instead of pulsing the oxidant as described above, the flowrate of oxidant and steam could be kept constant and the flowrate of the fuel could be pulsed without substantially affecting the enhanced hydrogen generation capacity of the ATR. Similarly, the flowrate of steam could be pulsed while the flowrates of the oxidant and the fuel could be kept constant while achieving the same results as described above. This later approach may have limited benefits, because only the mass pulsed and the steam represents only ⅓ of the total flow.

As shown in FIG. 4 of the drawings, the action of pulsing the oxidant or other feed gas component into reactor 12 causes the average temperature of the partial oxidation catalyst 20 to increase and decrease according to the amount of oxidant introduced. The average temperature of the partial oxidation catalyst 20 will also increase and decrease depending upon the instantaneous stoichiometric ratio of the process gases. With reference to FIG. 4, line 54 illustrates the average temperature of the partial oxidation catalyst 20, while line 56 represents the average temperature of the steam methane reforming catalyst.

In FIG. 4, it will be noted that as the temperature of the partial oxidation catalyst 20 increases, the thermal energy wave created passes downstream to the steam methane reforming catalyst 22. As illustrated in FIG. 4, the peak 58 of the steam methane reforming catalyst temperature is slightly out of phase with peak 60 of the partial oxidation catalyst temperature wave.

As less oxidant or air is introduced into the reaction, the hydrogen gas concentration in the product stream 44 increases, and this is illustrated in FIG. 5 of the drawings. The change in oxidant concentration in the reaction mixture caused by varying the amount of oxidant introduced into the mixture by the pulsating flow controller, causes a shift in the equilibrium conditions within the reaction mixture. Thus, the amount of heat generated by the exothermic reaction during the partial oxidation of the reactants causes a variation in the adiabatic operating temperature of the reaction. For example, it is expected that the adiabatic temperature of the partial oxidation catalyst would fluctuate between 1300 F. degrees and 1800 degrees F. when the oxidant flow is varied between 0.10 and 0.30 percent of the stoichiometric ratio required for the reaction.

By adjusting the length, width and cell density characteristics of the catalyst in catalyst layers 20 and 22 of the autothermal reformer section 24, and by tuning the pulse-width frequency and amplitude of flow of the feed-gas component stream, enhanced combustion and chemical reaction characteristics can be achieved. This fine-tuning capability or characteristic is based on the fact that the momentum or pressure wave, the thermal wave, and the chemical composition wave, will travel at different rates through the catalyst module consisting of the first and second sections or stages 16 and 18. The SMR Section 18 can be in heat transfer relationship with a source of combustion energy and the propagating momentum wave gas.

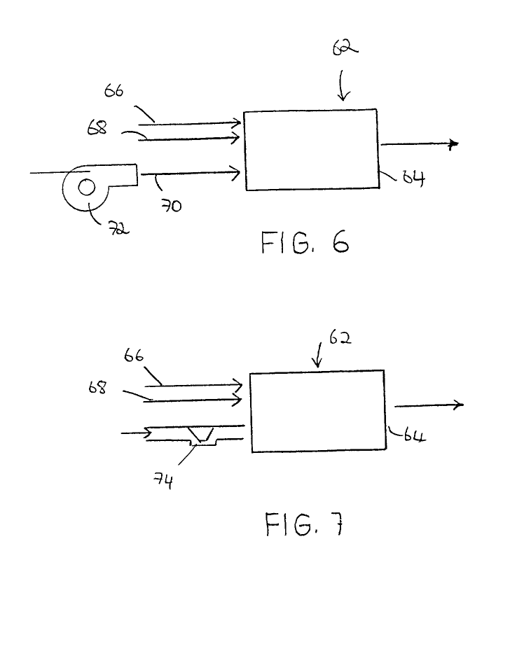

FIGS. 6 and 7 show, in schematic form, various alternative embodiments of the invention illustrated in the preceding drawings. In FIG. 6, there is shown an autothermal reformer 62 including (although not specifically illustrated) the catalyzed partial oxidation catalyst and the steam methane reforming catalyst of the type shown in FIG. 2 of the drawings. These are contained within the reactor shell 64. Steam and fuel enter the system through lines 66 and 68 respectively, Air or oxidant enters the system though line 70, and all are mixed and treated in the autothermal reformer. The oxidant is subject to the action of a variable speed process air blower 72, which is operated in the pulsed mode.

A blower of the type discussed could be a centrifugal compressor or blower, which is driven by an electric motor connected to a variable speed drive. Alternately, the blower could also be connected to an internal combustion engine with a variable governor for automatically modulating the shaft speed between a specified or predetermined range. In yet a further alternative, a piston compressor connected to a variable speed motor or internal combustion engine could also be used to provide a cyclically modulated flow of oxidant to the ATR.

In FIG. 7 of the drawings, essentially the same components are illustrated as those in FIG. 6. However, in FIG. 7 the oxidant introduced into the system passes through a flapper valve 74, which is preferably spring loaded to create pulsed flow of the oxidant. Such a valve has an internal, integral, feedback mechanism to reduce the flow of air by constricting the flow when the pressure is above the required range and to increase the flow of air by removing the constriction to flow when the pressure is below the required range. Such flow-control devices are well known and are readily available in the US from manufacturers such as Honeywell, Barber-Colman, etc.

In another embodiment, ordinarily available pneumatically or electrically valves with a zero-dampening factor in their control loops to provide oscillatory flow could also be used to provide the same operational performance. Such techniques for inducing oscillatory flow in valves are well known.

In both of the embodiments shown in FIGS. 6 and 7, the enhanced operation and characteristics of the invention will be seen by virtue of introducing air or oxidant not as a constant flow but in a pulsed mode. The yield of hydrogen from the ATR is thus improved, as discussed above.

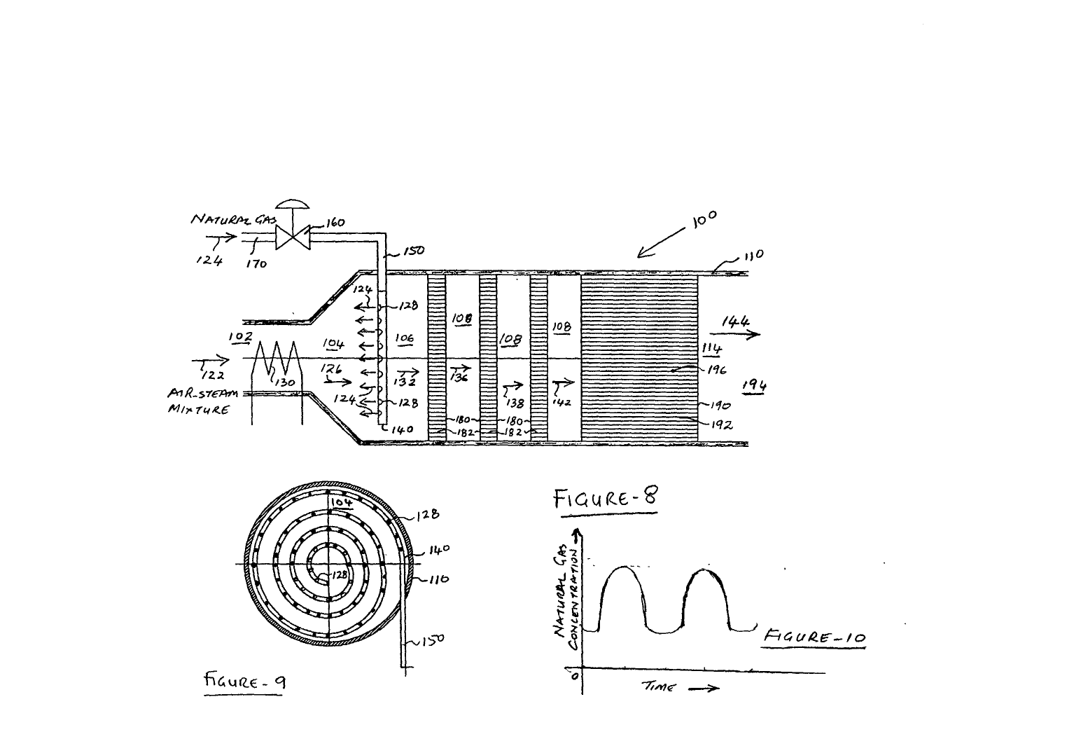

Yet another representation of an improved ATR, which utilizes pulsed fuel flow to achieve higher concentration of hydrogen in the high hydrogen concentration stream (also known as a reformate stream) is shown in FIG. 8 of the drawings. The improved ATR is generally represented as 100 and includes a casing 110 wherein a fuel distribution device 140, resonance creating devices 180, and advanced catalyst 190 are located. Casing 110 can be configured as a cylindrical tube though other configurations such as square tubes can also be used.

At one end, the casing 110 is connected to a gas inlet connection 120 through a transition piece 112. A mixture of air and steam is introduced into inlet connection 120 and into casing 110 through inlet opening 102 in inlet connection 120. At its other end, the casing 110 has an outlet opening 194 through which the reformate 144 is removed from the ATR 100.

An air-steam mixture 122 is introduced into ATR 100 through inlet 102 and passes into inlet connection 120. A heating device 130 is located in inlet connection 120 in the path of flow of air-steam mixture 122. The heating device 130 can be any device that can transfer heat to air-steam mixture 122 such as a steam coil, a hot water coil, a gas-gas heat exchanger, or an electric heater. The heating device 130 is intended to be a conceptual indication of preheating the process gases 122 and not a configuration specific hardware. This device could be a recuperative heating device designed to extract heat from the ATR exit gases 144 or a device that consists of a heat transfer surface with a combustor exhaust gas.

The air-steam mixture 122 is heated by heating device 130 and exits the heating device 130 at a temperature of between 800 degrees F. and 1600 degrees F. The heated air-steam mixture is shown as 126 in FIG. 8. The heated air-steam mixture 126 passes into mixing zone 104 wherein mixing device 140 is located. The mixing device 140 can be any suitable means for intimately mixing two gas streams. For example, the mixing device 140 can be a grid of tubes with gas injectors which is configured to substantially cover the cross-sectional area of zone 104 and which inject a first gas into a second gas that flows past the grid. The mixing device could also be a helical coil, as shown in FIG. 9, which is configured to substantially cover the cross-sectional area of the zone 104 and which is provided with injectors to inject a first gas into a second gas which is flowed past the helical coil. Other configurations can also be used.

In FIG. 8, the mixing device 140 is supplied with natural gas 124 through a connection 150. The connection 150 in turn is connected to the outlet end of a pulsating valve 160, which, as described above for the previous described embodiments, is configured for pulsating flow. The valve 160 in turn at its inlet end is connected to a flow connection 170 through which natural gas 124 is introduced into the mixing device 140. Thus natural gas 124 flows through the flow connection 170 into the pulsating valve 160 into the flow connection 150 and into the mixing device 140. The mixing device is equipped with gas injectors 128 to inject natural gas 124 into air-steam mixture stream 126 which flows past the mixing device 140. In FIG. 8, the gas injectors 128 are shown as orifices located on the mixing device 140 and which face the upstream direction of flow of the heated air-steam mixture stream 126. However, the gas injectors 128 could also be other specialized means of injecting gas such as nipples, etc. The upstream facing orientation of the gas injectors 128, relative to the heated air-steam mixture 126, shown in FIG. 8, provides for an intimate, rapid mixing of the natural gas 124 and the heated air-steam mixture 126 because of the head-on collision of the natural gas molecules and molecules.

The mixed gas-stream, shown in FIG. 8 as 132, now exits the mixing zone 104 into resonating device entry zone 106 from where it enters first a resonating device 180. As shown in FIG. 8, the first resonating device 180 is a cross-sectional slice of an uncoated monolith which is configured to cover the entire cross-section of the casing 110. The monolith has a plurality of straight flow passages 182 which are oriented with the longitudinal flow-path of the mixed gas 132 within the casing 110. The dimensions of the passages 182 are selected such that the mixed gas 132 flows in a plug flow manner within the passages 182. As defined herein, plug flow means a flow condition for a gas wherein the molecules of the gas are allowed to mix transversely within a flow passage but are not allowed to mix longitudinally within the flow passage. Thus under plug flow conditions, the concentration profile of the natural gas 124 in the mixed gas stream 132 is maintained as the mixed gas stream 132 flows through the casing 110.

The concentration of natural gas 124 in the mixed gas stream 132 can be varied in a periodic manner by alternately opening and closing valve 160. Thus by opening valve 160 there is created a short period of time when the concentration of natural gas 124 in the mixed gas stream 132 is in a predetermined range. This period is then followed by a time period wherein the valve 160 is closed so that the concentration of natural gas 124 in the mixed gas stream 132 is zero. This variation in concentration from a finite to a zero concentration creates “starved” flow conditions within the catalytic monolith 190. The variation of the hydrogen concentration with the catalytic monolith follows a periodic pattern as shown in FIG. 10. As will be described below, starved flow conditions increase the activity of the catalyst 196 in catalyst coated monolith 190 resulting in a higher concentration of hydrogen in the reformate 144.

Partially starved conditions wherein the concentration of natural gas 124 in the mixed gas stream 132 is varied between a higher value and a lower non-zero value can also be created by moving the valve between an open and a partially closed condition. The catalyst 196 will also provide better hydrogen generation efficiency under such partially starved conditions. The exact range of concentrations at which hydrogen concentration is maximized can be determined by experimentation, and can bet is expected to be between a predetermined percentage range.

The mixed gas stream 132 which is within the resonating device 180 passes into an intermediate zone 108 wherein it is shown as flow stream 136 in FIG. 8. Additional resonating stages can be provided to further maintain the concentration profile of the natural gas 124 in the mixed gas stream 132. Thus the flow stream 136 can be passed into a second resonating device 180 from where it exits as mixed gas stream 138. The flow stream 138 can further be passed into a third resonating device 180 from where it exits as mixed gas stream 142.

Te flow stream 142 is then passed into a catalyst coated monolith section 190 which is configured to cover the entire cross-section of the casing 110. The monolith 190 can have the same configuration as the monolith sections used in resonating devices 180. Alternatively, the monolith 190 can have a different configuration than that used in resonating devices 180. As shown in FIG. 8, the monolith 190 is configured with flow passages 192 which are oriented along the longitudinal flow path of mixed gas 142 in casing 110. These flow passages 192 can be dimensionally similar to, or different from, the flow passages 182 used in the monolith slices used in the resonating devices 180.

The passages 192 are coated with an advanced catalyst 196 which carry out the hydrogen reforming reactions described above for the previous embodiments. When the mixed gas 142 contacts the catalyst 196 in the flow passages 192, the partial oxidation and steam methane reforming reactions described above take place and the methane 124 in the mixed gas 142 reacts with the oxygen and the stream in mixed gas 142 to provide a hydrogen rich gas stream which is shown in FIG. 8 as 144. The hydrogen rich gas stream 144 exits passages 192 of the catalyst monolith 190 into exit zone 114 from where it is directed out of the casing 110 through an outlet 194.

As stated above, the use of starved conditions in the catalyst may improve the hydrogen generation efficiency of the catalyst.

For optimum operation, it is advantageous that the resonance time of the mixed gases within the resonating device and intermediate zone be kept within 50% to 200% of the cycle time of the valve pulsations. The resonance time may be calculated in seconds by dividing the flow volume of the mixed gas per second (at actual operating conditions) by the space volume contained in the resonating device and the intermediate zone.

The invention has many advantages including an increase in the overall hydrogen production over current ATRs which equivalent amounts of fuel. Therefore the hydrogen yield efficiency of the reforming system may be improved over the yields presently available in the art. Additionally, it will be seen, particularly with reference to the graphs in FIGS. 3, 4 and 5 of the drawings, that the heat transfer and catalytic activity of the apparatus and processes of the invention improves with the use of pulsed oxidant flow. An advantage of the invention is also that the product gas from a complete fuel processing system can be tuned by controlling the mixing volumes and flow resistances downstream, so as to have relatively constant hydrogen concentrations and flow rate. This allows the desirable result of relatively steady state fuel cell performance.

Furthermore, the product gas from the complete fuel processing system can be tuned by minimizing mixing volumes and flow resistances downstream, so as to have hydrogen concentration increases and decreases with the progression of the composition wave through the reactor. A benefit of this tuning ability is the possibility of increasing the overall carbon monoxide (CO) tolerance of the fuel cell system through momentary fuel starvation.

The invention utilizes hydrocarbon fuels for the production of hydrogen gas as its primary application, although other applications are of course possible and certainly within the scope of the invention. The hydrogen gas produced by the system of the invention can then preferably be used for fuel cell power generation applications in various devices, including both stationary and vehicular markets. The hydrogen produced in accordance with the invention can also be used for industrial hydrogen generation systems where hydrogen is the desired customer product.

While the above description is directed towards increasing the hydrogen yield of an ATR by cyclical pulsation of one of the feed gas components, it will be obvious to one of ordinary skill in the art that equivalent results could also be obtained by varying the composition of the active oxidant in the oxidant stream. Thus if air is used as an oxidant, the concentration of oxygen in the oxidant stream could be cyclically varied by injecting a cyclically varying amount of relatively pure oxygen into the oxidant stream to increase the concentration of oxygen in the oxidant stream. Such variations are considered as falling within the scope of this invention.

Therefore, the invention described herein should not be restricted by the above description but should be determined by reference to the appended claims.

1. An autothermal reactor for the generation of a hydrogen-containing product gas stream from a feed gas stream, the autothermal reactor comprising:
a reactor vessel having a feed gas stream inlet end and a product gas outlet end;
a partial oxidation catalyst located within the reactor vessel and positioned in the path of the feed gas stream;
a steam methane reforming catalyst located within the reactor vessel and positioned downstream from the partial oxidation catalyst in the path of the feed-gas stream;
a first inlet means to introduce a first feed gas stream component selected from the feed gas component stream group comprising a hydrocarbon fuel, oxidant, and steam, the first inlet means located at the fuel gas stream inlet end of the reactor vessel; and
means to pulsate associated with the first inlet means to pulsate the flow of the first feed gas stream component into the autothermal reactor.

2. The autothermal reactor of claim 1 further comprising a second inlet means to introduce a second feed gas stream component selected from the feed gas component stream group comprising a hydrocarbon fuel, oxidant, and steam, the second feed gas stream component being different from the first feed gas stream component, the second inlet means being located at the fuel gas stream inlet end of the reactor vessel.

3. The autothermal reactor of claim 2 further comprising a third inlet means to introduce a third feed gas stream component selected from the feed gas component stream group comprising a hydrocarbon fuel, oxidant, and steam, the third feed gas stream component being different from the first feed gas stream component and the second feed gas stream component, the third inlet means being located at the fuel gas stream inlet end of the reactor vessel.

4. The autothermal reactor of claim 3 wherein the first feed gas stream component is a hydrocarbon fuel, the second feed gas stream component is oxidant, and the third feed gas stream component is steam.

5. The autothermal reactor of claim 3 wherein the first feed gas stream component is oxidant, the second feed gas stream component is hydrocarbon fuel, and the third feed gas stream component is steam.

6. The autothermal reactor of claim 1 wherein the reactor vessel includes a mixing zone for the mixing of the feed gas component stream, the mixing zone being located upstream of the partial oxidation catalyst.

7. The autothermal reactor of claim 6 wherein the mixing zone consists of a series of non-catalyzed monolith slices spaced apart, such that the resonance time within the slice-space combination is from 50% to 200% of the cycle time of the pulsing.

8. The autothermal reactor of claim 1 wherein the partial oxidation catalyst is selected from the group consisting of a nickel-based catalyst, a precious metal-based catalyst, and a precious metal-based catalyst with a metal-oxide promoter.

9. The autothermal reactor of claim 1 wherein the partial oxidation catalyst is configured as pellets.

10. The autothermal reactor of claim 1 wherein the partial oxidation catalyst is configured as monoliths.

11. The autothermal reactor of claim 1 wherein the steam methane reforming catalyst is a metal-oxide-based catalyst.

12. The autothermal reactor of claim 1 wherein the means to pulsate first feed gas stream component flow is a flow control element.

13. The autothermal reactor of claim 12 wherein the flow control element is an actuator operated flow control valve whose actuator is cyclically driven between two predetermined positions by a pre-programmed control logic.

14. The autothermal reactor of claim 12 wherein the flow control element is an actuator operated flow control valve whose actuator is cyclically driven between two predetermined positions by a mechanically linked feed-back system which throttles or opens the flow-control valve in inverse relationship to the pressure.

15. The autothermal reactor of claim 12 wherein the flow control element is an feedback loop based flow-control valve whose actuator is cyclically driven between two predetermined positions by incorporating a zero-dampening factor in its feed-back control system.

16. The autothermal reactor of claim 1 wherein the means to pulsate the first feed-gas stream component flow is a rotating gas compressor whose operation develops pulsed flow characteristics.

17. The autothermal reactor of claim 1 wherein the means to pulsate first feed-gas stream component flow is a peristaltic flow movement device.

18. The autothermal reactor of claim 1 further comprising downstream components to further process the gases; and said downstream components are designed to propagate the pulsed flow characteristics developed in the ATR into the fuel cell to enhance CO tolerance of the fuel cell.

19. The autothermal reactor of claim 1 further comprising downstream components to further process the gases; and said downstream components are designed to dampen pulsed flow characteristics developed in the ATR such that it does not propagate into the fuel cell.

20. A method of generating a hydrogen-containing product gas from an autothermal reactor containing a partial oxidation catalyst and a steam methane reforming catalyst, the method comprising the steps of:
pulsatingly introducing a feed gas mixture comprising a first feed gas stream component selected from the feed gas component group comprising a hydrocarbon fuel, oxidant, and steam into the autothermal reactor;
passing the feed gas mixture over the partial oxidation catalyst to produce a partially oxidized product gas stream;
passing the feed gas mixture over the steam methane reforming catalyst to generate the hydrogen-containing product gas stream; and
removing the hydrogen-containing product gas stream generated from the autothermal reactor.

21. The method as claimed in claim 20 further comprising introducing into the autothermal reactor a second feed gas stream component selected from the group comprising a hydrocarbon fuel, oxidant, and steam, the second feed gas stream component being different from the first feed gas stream component, and mixing the first and second feed gas stream components to produce the feed gas mixture.

22. The method as claimed in claim 21 further comprising introducing into the autothermal reactor a third feed gas stream component selected from the group comprising a hydrocarbon fuel, oxidant, and steam, the third feed gas stream component being different from the first feed gas stream component and the second feed gas stream component; and mixing the first, second and third feed gas stream components to produce the feed gas mixture.

23. The method as claimed in claim 22 wherein the first feed gas stream component is a hydrocarbon fuel, the second feed gas stream component is an oxidant and the third feed gas stream component is steam.

24. The method as claimed in claim 22 wherein the first feed gas stream component is oxidant, the second feed gas stream component is a hydrocarbon fuel, and the third feed gas stream component is steam.

25. The method as claimed in claim 20 wherein the partial oxidation catalyst is selected from the group consisting of a nickel-based catalyst, a precious metal-based catalyst, and a precious metal-based catalyst with a metal-oxide promoter.

26. The method as claimed in claim 20 wherein the partial oxidation catalyst is configured as pellets.

27. The method as claimed in claim 20 wherein the partial oxidation catalyst is configured as monoliths.

28. The method as claimed in claim 20 wherein the pulsating introduction of the first feed-gas stream component flow is created by a flow control element.

29. The method as claimed in claim 28 wherein the pulsating introduction creates a peristaltic flow movement.
